(19) United States
(12) Patent Application Publication
(10) Pub. No.: US 2024/0366337 A1
(43) Pub. Date: Nov. 7, 2024

(54) SYSTEM FOR CLEANING A ROOT CANAL OF A TOOTH, AND RELATED COMPONENTS AND METHODS

(71) Applicant: Aseptico, Inc., Woodinville, WA (US)

(72) Inventors: Kenneth Scott Lewallen, Everett, WA (US); James Shipley, Monroe, WA (US)

(73) Assignee: Aseptico, Inc., woodinville, WA (US)

(21) Appl. No.: 18/311,766

(22) Filed: May 3, 2023

(51) Int. Cl. A61C 5/40

(52) U.S. Cl. CPC A61C 5/40

(57) ABSTRACT

An apparatus for heating and agitating an irrigant inside a tooth's root canal includes a first portion and a second portion. The first portion is sized and configured to extend into the tooth's root canal via a hole in the tooth's dentin, and is operable to heat and physically agitate an irrigant disposed in a tooth's root canal. The second portion is sized and configured to move the first portion while the first portion extends into the tooth's root canal, and is operable to move the first portion in response to a driving force that the second portion receives. With the ability of the device's first portion to heat and agitate an antiseptic irrigant disposed inside a tooth's inner chamber, one can use the activator to simultaneously heat and agitate the irrigant.

### BACKGROUND

Root canals are common medical procedures that dentists use to remove infected or otherwise damaged pulp from a tooth. A tooth's pulp includes nerves, blood vessels, and other important tissues that help maintain the life and health of the tooth. If the pulp becomes infected or otherwise damaged, the infection and/or damage could spread into one's jaw that anchors the tooth, and then, possibly spread to other portions of one's body.

The procedure for removing damaged pulp from a tooth includes drilling a hole through the tooth's enamel, which is the tooth's outer layer, to expose the chamber inside the tooth where the pulp is located and to gain access to the pulp. The chamber typically includes a large top portion and a smaller canal portion that extends from the top portion into the root of the tooth. Typically, a hole is drilled through the tooth's crown. Next, the pulp is removed from the top chamber. This is typically done by inserting an extirpating file into the cavity via the hole and rotating the file inside the cavity with a reciprocating, twisting motion. An extirpating file has a long narrow body, similar to a pin, that includes many little barbs along the body to snag and hold pulp when the file is rotated inside the cavity. With much of the pulp removed from the top cavity, the pulp in the canal portion needs to then be removed. This is done by first shaping and then irrigating the canal. Shaping typically involves using another file—an endodontic file—to break up the pulp in the canal and remove material from the wall of the canal to facilitate irrigation. Irrigating the canal disinfects the canal, and dissolves the broken-up pulp and organic material that is smeared on the walls of the canal from the shaping operation. Irrigating typically involves flushing the shaped canal with an antiseptic irrigant, such as sodium hypochlorite, then activating the irrigant to promote the dissolution of the pulp and smeared organic material.

Currently, there are two ways to activate the antiseptic irrigant. One includes heating the irrigant; the other, agitating the irrigant. When the irrigant is both heated and agitated, the efficiency of the irrigating step increases, which results in a cleaner, more sterile canal. Unfortunately, though, the antiseptic irrigant is typically not activated by both heat and agitation. Rather, the antiseptic irrigant is activated by either heating the irrigant with a heated plugger, which is similar to an extirpating file except without the barbs, or by agitating the irrigant with sound waves, or additional irrigant injected into the canal. The reason for this is that heating the irrigant and agitating the irrigant require two different tools, and thus are not done at the same time, but rather sequentially. Being done in sequence loses some of the synergistic effect of agitating warm irrigant, because the volume of the irrigant being heated is so small that most if not all of the heat that the heated plugger adds to the irrigant escapes into the surrounding tissue before the irrigant can be agitated. And agitating the irrigant before heating it suffers from the same problem—the irrigant quickly loses its motion when the irrigant is no longer physically agitated.

Thus, there is a need for a single tool that can both heat and agitate the irrigant at the same time.

### SUMMARY

In one aspect of the invention, an activator for heating and agitating an irrigant inside a tooth's root canal includes a first portion and a second portion. The first portion is sized and configured to extend into the tooth's root canal via a hole in the tooth's dentin, and is operable to heat and physically agitate an irrigant disposed in a tooth's root canal. The second portion is sized and configured to move the first portion while the first portion extends into the tooth's root canal, and is operable to move the first portion in response to a driving force that the second portion receives. In some embodiments the first portion is operable to simultaneously heat and physically agitate an irrigant disposed in a tooth's root canal.

With the ability of the device's first portion to heat and agitate an antiseptic irrigant disposed inside a tooth's inner chamber, one can use the activator to simultaneously heat and agitate the irrigant. This increases the efficiency of the irrigant in cleaning the inner chamber and its canal portion, and in dissolving pulp and other organic material inside the inner chamber and smeared on the inner chamber's walls. In addition, the ability of the device's first portion to heat and agitate an antiseptic irrigant disposed inside a tooth's inner chamber, allows one to use a single tool to either heat, agitate, or sequentially heat and agitate without multiple insertions and removals into and out of the tooth's chamber.

In another aspect of the invention, a method for heating and physically agitating an irrigant inside a tooth's root canal includes: 1) extending a first portion of an activator into the pulp chamber of a tooth; 2) generating heat in the first portion of the activator; 3) generating a driving force; 4) exposing a second portion of the activator to the driving force; 5) with the driving force, moving the second portion of the activator; and 6) with the second portion's movement, moving the first portion of the activator.

In yet another aspect of the invention, a system for heating and agitating an irrigant inside a tooth's root canal includes a handpiece, and an activator. The handpiece includes a body sized and configured to be held by a dental professional, and a coupling interface that includes a driver operable to generate a driving force. The activator includes a first portion, and a second portion. The first portion is sized and configured to extend into the tooth's root canal via a hole in the tooth's dentin, and is operable to heat and physically agitate an irrigant disposed in the tooth's root canal. The second portion of the activator is coupleable with the handpiece's coupling interface. The second portion is also sized and configured to move the first portion while the first portion extends into the tooth's root canal in response to the driving force generated by the handpiece's driver.

In still another aspect of the invention, a method for cleaning a root canal includes: 1) coupling an activator to a coupling interface of a handpiece, wherein: a) the activator includes a first portion and a second portion, b) the coupling interface of the handpiece includes a driver, and c) the activator's second portion is coupled with the handpiece's coupling interface; 2) extending the first portion of the activator into the pulp cavity of a tooth; 3) generating heat in the first portion of the activator; 4) with the driver, generating a driving force; 5) exposing a second portion of the activator to the driving force; 6) with the driving force, moving the second portion of the activator; and 7) with the second portion's movement, moving the first portion of the activator.

### BRIEF DESCRIPTION OF THE DRAWINGS

FIG. 1 shows a perspective view of a system for heating and agitating an irrigant inside a tooth's root canal, according to an embodiment of the invention.

Each of FIGS. 2A and 2B shows a partial view of the system shown in FIG. 1, according to an embodiment of the invention. FIG. 2A shows the activator 22 of the system 20 at rest; and FIG. 2B shows the activator 22 in action.

FIG. 3 shows a partial side view of the system shown in FIG. 1, according to an embodiment of the invention.

FIG. 4 shows a perspective view of the activator shown in FIGS. 1-3, according to an embodiment of the invention.

FIG. 5 shows an activator, according to another embodiment of the invention.

FIG. 6 shows an activator, according to yet another embodiment of the invention.

FIG. 7 shows a portion of system for heating and agitating an irrigant inside a tooth's root canal, according to another embodiment of the invention.

### DETAILED DESCRIPTION

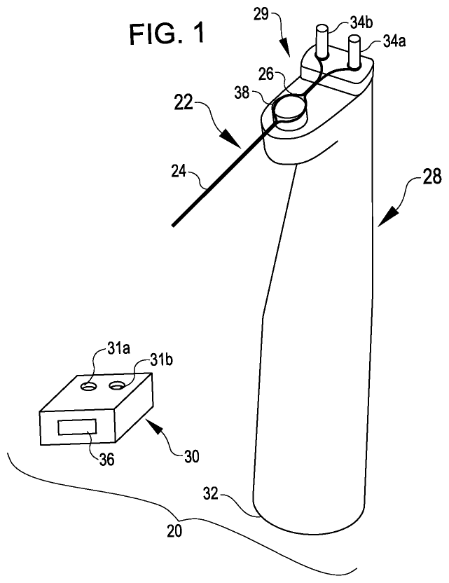

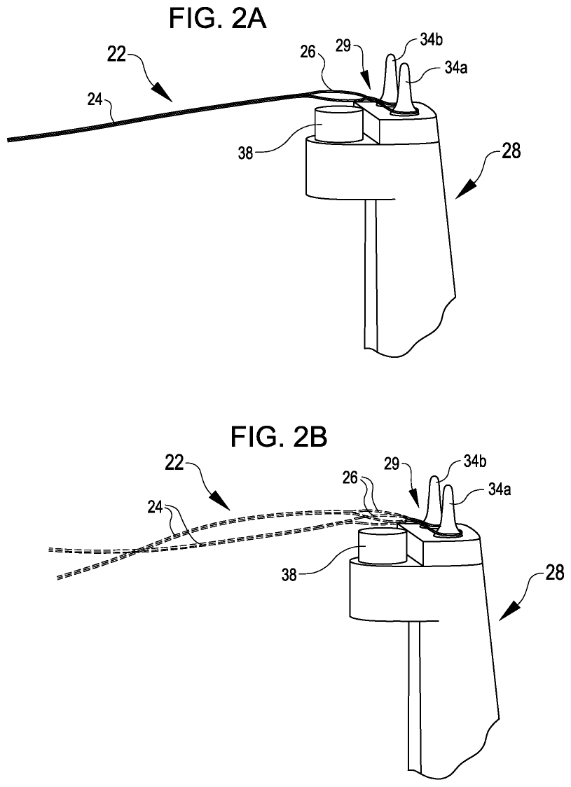

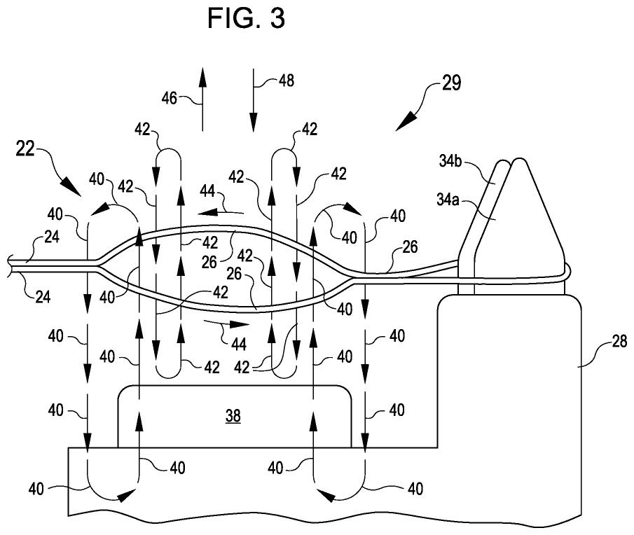

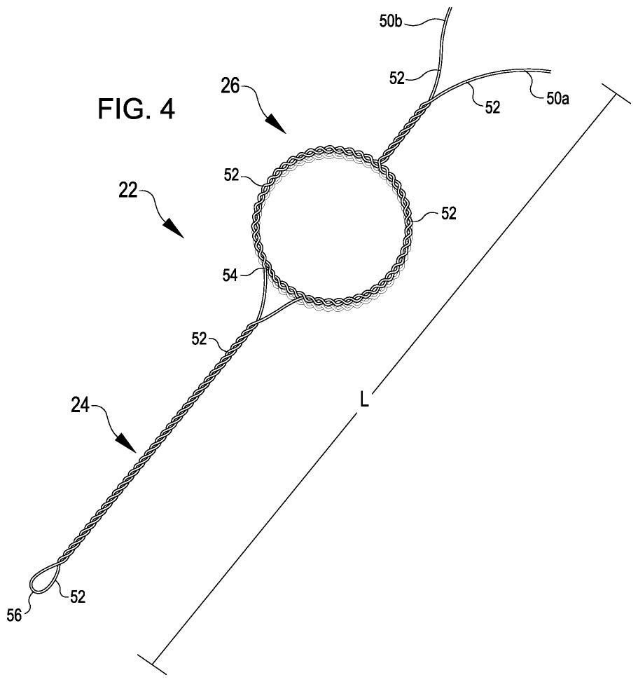

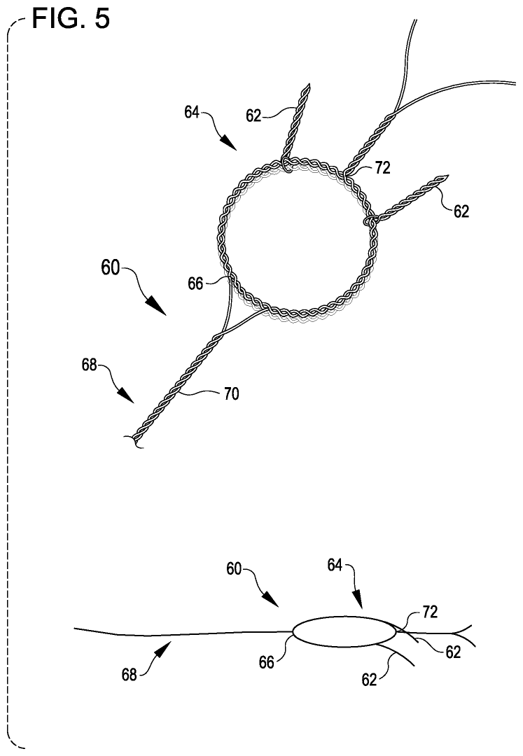

FIG. 1 shows a perspective view of a system 20 that may be used to activate an irrigant inside a tooth's root canal, according to an embodiment of the invention. The system 20 includes an activator 22 (discussed in greater detail in conjunction with FIGS. 4 and 5) that includes a first portion 24 that activates an irrigant, and a second portion 26 that drives the first portion 24. The irrigant (not shown) may be any irrigant that is used in any process and that functions better when activated—e.g., heated, agitated, and/or both. Here, the irrigant is sodium hypochlorite and is used to disinfect and clean a tooth's root canal (not shown) and pulp chamber (also not shown), and to dissolve pulp and other organic matter inside a tooth's root canal that has been broken up inside the canal and/or that may be smeared on a wall of the canal. The irrigant, however, may be any other desired irrigant capable of disinfecting and cleaning a tooth's canal and pulp chamber. The system 20 also includes a handpiece 28 that has a coupling interface 29 where the activator 22 is releasably coupled with the handpiece 28, and a base station 30. The activator 22 activates the irrigant by heating the irrigant, physically agitating the irrigant, or heating and agitating, simultaneously or sequentially, the irrigant. The handpiece 28 includes a driver that generates a driving force (discussed in greater detail in conjunction with FIG. 3). The driving force moves the second portion 26 of the activator 22, that, in turn, moves the first portion 24 of the activator 22. When the activator 22 is inserted into a tooth's root canal and/or pulp chamber, and the handpiece's driver is engaged, the first portion 24 of the activator 22 generates heat and moves inside the root canal and/or pulp chamber, and thus activates the irrigant that is also inside the root canal and/or pulp chamber.

With the ability of the activator's first portion 24 to heat and agitate an irrigant disposed inside a tooth's root canal and/or pulp chamber, one can use the activator 22 to simultaneously heat and agitate the irrigant. This increases the efficiency of the irrigant in cleaning the root canal and/or pulp chamber, and in dissolving pulp and other organic material inside the root canal and/or pulp chamber and that may be smeared on the inner chamber's walls. In addition, the ability of the activator's first portion 24 to heat and agitate an irrigant disposed inside a tooth's root canal and/or pulp chamber, allows one to use a single tool to either heat, agitate, or sequentially heat and agitate without multiple insertions and removals into and out of the tooth's root canal and/or pulp chamber.

Still referring to FIG. 1, the base station 30 may be configured as desired to hold, charge, and otherwise support the handpiece 28 when the handpiece 28 and activator 22 are not being used. For example, in this and other embodiments, the base station 30 includes a receptacle (here two 31a and 31b) that is sized and configured to receive the handpiece 28, and a user interface 36 to allow one to monitor circuitry (not shown) in the handpiece 28 that energizes the handpiece's driver, and modify the circuitry's output as desired to power the activator 22 as desired. More specifically, when the bottom 32 of the handpiece 28 is positioned in the receptacle 31a or 31b, the receptacle 31a or 31b provides and maintains an electric connection between the base station and the handpiece's circuitry. With this electric connection, the user interface 36 may be used to display the output and functionality of the handpiece's circuitry, and charge a battery (not shown) disposed in the handpiece 28 that allows one to use the handpiece 28 and activator 22 without having the handpiece 28 plugged into an electrical outlet. Each of the receptacles 31a and 31b also physically holds the bottom 32 to provide the handpiece 28 a docking station where the handpiece 28 may be stored while being charged and/or not being used.

Each of FIGS. 2A and 2B shows a partial view of the system shown in FIG. 1, according to an embodiment of the invention. FIG. 2A shows the activator 22 of the system 20 at rest; and FIG. 2B shows the activator 22 in action. Together these views show how the activator 22 moves when the handpiece 28 drives the activator's second portion 26, according to an embodiment of the invention.

In this and other embodiments, when the activator is at rest (shown in FIG. 2A), the activator's first portion 24 may be inserted into a tooth's pulp chamber and/or root canal through a hole (not shown) in the tooth's enamel (also not shown). The hole may be located anywhere on the tooth that provides the desired access to the pulp chamber and/or root canal. For example, the hole is typically located in the crown (not shown) of a tooth to facilitate access to the hole, but the hole may be located in other regions of the tooth, such as the tooth's neck and root. Once the activator's first portion 24 is positioned inside the tooth's pulp chamber and/or root canal, one energizes the handpiece's driver. When energized, the driver generates an electric potential across a pair of leads 34a and 34b of the handpiece 28. The potential causes a current of electricity to flow through the first and second portions 24 and 26. When the current flows through the activator's first portion 24, the first portion's resistance to this current generates heat in the first portion 24 that then radiates into the irrigant that surrounds the first portion 24. When the current flows through the activator's second portion 26, the current generates an electromagnetic field (shown and discussed in greater detail in conjunction with FIG. 3) that reacts with a magnetic field (also shown and discussed in greater detail in conjunction with FIG. 3) that is generated by the magnet 38 of the handpiece's driver. This interaction between the electromagnetic field generated in the activator's second portion 26 and the magnetic field generated by the magnet 38 of the handpiece's driver generates the driving force that moves the activator's second and first portions 24 and 26, respectively. When the first portion 24 moves, the irrigant surrounding the first portion 24 is physically agitated. In this manner, the activator's first portion 24 activates the irrigant by heating and physically agitating the irrigant simultaneously.

The heat generated by the first portion 24 of the activator 22 may be generated in any desired manner. For example, in this and other embodiments the resistance of the activator's first portion 24 to the electricity flowing through it generates the heat. Thus, the amount of heat generated may be controlled or modified by changing the electrical resistance of the activator's first portion 24, changing the amount of electricity flowing through the first portion 24, or both. In other embodiments, the first portion 24 may generate heat via inductive heating in which a magnetic field generates eddy currents of electricity in the activator's first portion 24 that then generates heat by resisting the flow of electricity in these eddy currents.

The motion of the activator's first portion 26 may be any desired motion capable of physically agitating the irrigant that surrounds it. For example, in this and other embodiments the driving force vibrates the activator's second portion 26 at a frequency that generates a standing wave in the activator 22. Because the distal end of the activator's first portion 24 is free, or not fixed (unlike the proximal end of the second portion 26 that is coupled with the handpiece's coupling interface 29), vibrating the second portion 26 at a resonant frequency of the activator 22 generates a standing wave in the activator 22 in which the distal end (the free end) of the first portion 24 vibrates. When vibrating in this manner, the tooth's enamel that surrounds the hole through which the first portion 24 extends could interfere or confine the movement of the first portion 24. In such instances, the first portion 24 will continue to vibrate, but will generate a wave pattern that does not mimic one of the wave patterns generated in an activator 22 whose length is unconstrained. When the activator 22 vibrates as a standing wave and the size of the cross-section of the activator's first portion 24 is substantially smaller than the size of the hole through the tooth's enamel that the first portion 24 extends through, then the vibration of the activator's first portion 24 is minimally if at all confined by the tooth. Similarly, when the node of the standing wave (the location along the length of the activator 22 that does not vibrate) is located at the hole in the tooth through which the first portion 24 extends, then the vibration of the activator's first portion is minimally if at all confined by the tooth.

Other embodiments are possible. For example, the driving force may vibrate the activator's second portion 26 at a frequency that is not a resonant frequency of the activator 22, and thus does not generate a standing wave in the activator 22. This may be desirable to obtain in the distal end of the activator's first portion 24 different action or motion. This motion may change in amplitude over time, in direction over time, and/or both.

FIG. 3 shows a partial side view of the system 20 in FIG. 1, according to an embodiment of the invention. The interaction of the magnetic fields 40 and 42 located in the handpiece's coupling interface 29 generate the driving force that moves the activator's second portion 26. By controlling and modifying one of these magnetic fields, one can generate a driving force that oscillates over time and thus can vibrate the activator's second portion 24.

In this and other embodiments, the magnet 38 generates a magnetic field (indicated by the arrows 40, only 13 of 21 arrows labeled for clarity), and electricity flowing through the activator's second portion 26 generates an electromagnetic field (indicated by the arrows 42). The direction of the arrows 40 and 42 indicate the polarity of the respective magnetic field that each represents. The polarity and strength of the magnetic field 40 does not change over time, while the polarity and strength of the electromagnetic field 42 does. The strength of the electromagnetic field 42 is directly proportional to the amount of electricity flowing through the activator's second portion 24, and the polarity of the field 42 depends on the direction (indicated by the arrow 44) that the electricity flows through the second portion 26. By changing the electric potential that the handpiece's driver provides across the leads 32 and 34 in the handpiece's coupling interface 29, one can modify both the strength and polarity of the electromagnetic field 42. For example, when the electricity flows through the second portion 26 in the direction of the arrow 44, the polarity of the electromagnetic field 42 matches the polarity of the magnetic field 40 (as shown in FIG. 3). When this happens the fields 40 and 42 repel each other, which generates a driving force in the direction of the arrow 46 relative to the magnet 38. This, in turn, urges the second portion 26 away from the magnet 38 in the direction of the arrow 46. When the electricity flows through the second portion 26 in the direction opposite the direction of the arrow 44, the polarity of the electromagnetic field 42 is opposite the polarity of the magnetic field 40. When this happens the fields 40 and 42 attract each other, which generates a driving force in the direction of the arrow 48 relative to the magnet 38. This, in turn, urges the second portion 26 toward the magnet 38 in the direction of the arrow 48.

The handpiece's driver may provide an electric potential (power) to the leads 32 and 34 in any desired form over time. For example, in this and other embodiments the handpiece's driver provides alternating current (AC) as a rectangular wave with a 15% duty cycle. In this form, voltage to the leads is provided such that electricity flows in the direction of the arrow 44 for 15% percent of the waveform's period. Because the handpiece's driver provides alternating current to the leads, when the present waveform's period ends, the handpiece driver swaps the voltage across the leads 32 and 34 so that electricity then flows in the direction opposite the direction of the arrow 44. As an example, with this waveform the handpiece's driver may provide +2 volts across the leads 32 and 34 for 1.5 milliseconds. Then, the driver may provide 0 volts to the leads 32 and 34 for 10 milliseconds. Then, the driver may provide −2 volts across the leads 32 and 34 for 1.5 milliseconds. Then, the driver may provide 0 volts across the leads 32 and 34 for another 10 milliseconds. This sequence is then repeated for as long as desired. The frequency of the waveform is the total number of occurrences of this sequence within a specific time period. If the above sequence included +2 volts for 0.75 milliseconds followed by 0 volts for 5 milliseconds, followed by −2 volts for 0.75 milliseconds, followed by 0 volts for 5 milliseconds, then the frequency of this sequence would be twice the frequency of the previous sequence.

With an AC rectangular waveform, the driving force that is generated both provides a quick, powerful force that pushes the second portion 26 away from the magnet 38 and then pulls the second portion 26 toward the magnet 38. Other forms are possible. For example, the handpiece's driver may provide direct current (DC) that pulses over time—i.e. whose voltage changes over time but whose direction does not, unlike AC. The pulses may be configured such that they provide a rectangular form, a sawtooth form, or a pyramid form, with a 50% duty cycle. This may be desirable when heating the irrigant has more influence over the activation of the irrigant than physically agitating the irrigant. With a pulsed DC form, the interaction between the two magnetic fields 40 and 42 only provides the driving force in a single direction, which may be the direction indicated by either one of the arrows 46 and 48. The portion of the driving force in the opposite direction is provided by the elastic response of the second portion 26 returning to its at-rest position. Because electricity flows through the first portion 24 for half of the time in one sequence, the first portion 24 generates a lot of heat quickly. And because the interaction between the two magnetic fields 40 and 42 does not provide a driving force in both directions, the distance that the distal end of the first portion 24 moves while powered is less than the distance when the handpiece's driver provides an AC waveform.

In still other embodiments, the handpiece's driver may provide AC as a sine wave, a sawtooth wave, and or a pyramid wave, with a 20% duty cycle.

FIG. 4 shows a perspective view of the activator 22 shown in FIGS. 1-3, according to an embodiment of the invention. As previously mentioned, the activator 22 is releasably coupled to the handpiece's coupling interface (29 in FIGS. 1-3), and includes a first portion 24 that activates an irrigant via heat, physical agitation, or heat and agitation, either simultaneously or sequentially; and a second portion 26 that drives the first portion 24.

The activator 22 may be releasably coupled with the coupling interface using any desired technique that allows the second portion 26 to move in response to a driving force, yet remain physically and electrically attached to coupling interface (29). For example, in this and other embodiments the activator 22 is coupled to the leads 34a and 34b in such a way that the coupling provides both a physical and an electrical attachment to the handpiece (28 in FIGS. 1-3). More specifically, the proximal end of the second portion 26 includes two leads 50a and 50b, each one wound around a respective one of the two leads 34a and 34b of the coupling interface (29). This allows one to quickly and easily remove an activator 22 from the handpiece 28 and then couple another, different activator 22 to the handpiece 28 in response to a change in the circumstances of a root canal procedure.

Still referring to FIG. 4, the first and second portions 24 and 26, respectively, may be configured as desired to activate an irrigant. For example, in this and other embodiments, the first portion 24 includes a section of a single wire 52, and the second portion 26 includes a different section of the same, single wire 52. The single wire 52 may be sized and configured to provide a desired heat and motion response to a specific and/or range of voltages applied to the leads 34a and 34b. More specifically, the activator 22 has a total length L, which may range between 0.5 and 1.5 inches, and the single wire 52 has a diameter that may range between 0.1 mm and 0.4 mm. The first portion 24 has a length of about 0.7 L, and the second portion 26 has a length of about 0.3 L. To provide a circuit for electricity to flow through the first portion 24 and a desired stiffness in the first portion 24, the section of the single wire 52 that the first portion 24 includes is braided or twisted, and extends from the distal end 54 of the second portion 26 out to the distal end 56 of the first portion 24, and then back to the distal end 54 of the second portion 26 where it continues through the second portion 26. The second portion 26 includes a loop or coil (here four) to increase the strength of the electromagnetic field that is generated by the flow of electricity through the second portion 26, and thus increase the strength of the driving force. All of the coils are coupled with each other so that none of the individual coils moves relative to the other coils when the driving force generated by the handpiece's driver acts on each of the coils. In this manner, some of the driving force is not lost or wasted in the second portion 26; but rather, much of the driving force goes to moving the second portion 26, as a whole. The coils may be coupled together using any desired technique. For example, in this and other embodiments the coils are glued together. In other embodiments, the coils may be wound around a bobbin much like thread around a spool.

Other embodiments are possible. For example, the total length L may be any length less than 0.5 inches or greater than 1.5 inches. As another example, the length of the first portion 24 of the activator 22 may be less than or greater than 0.7 L, and the length of the second portion 26 of the activator 22 may be less than or greater than 0.3 L. As another example, the diameter of the single wire may be less than 0.1 mm and/or greater than 0.4 mm, and the diameter of the wire may change depending on the section of the wire and where that section is located in the portions 24 and 26 of the activator 22. As yet another example, the second portion 26 may not include any coil or loop. As yet another example, the first portion 24 of the activator 22 may not include a twisted wire but rather a single wire that only doubles back on itself at the distal end of the first portion 24. And as yet another example, the first portion 24 of the activator 22 may include a first wire, and the second portion 26 of the activator 22 may include a second wire. The first and second wires may be parallel or in series, electrically. If parallel to each other, then the first and second wires are physically coupled so that movement of the second portion 26 drives the movement of the first portion 24 in response. If the two wires are in series, then the first and second wires are coupled to allow electricity to flow through one of the wires and then through the other wire.

The material of the activator 22 may be any material that provides the desired combination of electrical resistance and elastic response to a desired driving force. For example, in this and other embodiments the material of the single wire includes copper. In other embodiments, the material includes aluminum.

Other embodiments are possible. For example, the activator 22 may not include a single wire 52 that forms both the first portion 24 and the second portion 26, but rather the first and second portions 24 and 26, respectively, may each be formed of wire that is separate from the wire that forms the other portion 26 or 24. In this manner, the material and configuration of the first portion 24 may be designed to emphasize heating and/or agitation in response to movement of the second portion 26, and the material and configuration of second portion 26 may be designed to emphasize it's response to the driving force generated by the handpiece's driver.

FIG. 5 shows an activator 60, according to another embodiment of the invention. The activator 60 is similar to the activator 22 shown and discussed in conjunction with FIGS. 1-4, except that the activator 60 includes a brace 62 that helps support the second portion 64 of the activator 60, and influences the response of the second portion 64 to the driving force generated by the handpiece's driver (not shown).

The brace 62 may be sized and configured as desired to provide the desired support and response. For example, in this and other embodiments the brace 60 includes two legs, each extending from a location along the perimeter of the second portion's loop, and toward the portion of the coupling interface (29 in FIGS. 1-3) of the handpiece (28 in FIGS. 1-3) that lies adjacent the magnet (38 in FIGS. 1-3). More specifically, each leg of the brace 62 is fixed to the second portion's loop, but does not carry any electrical current when electricity flows through the second portion 64. Each leg simply contacts the portion of the handpiece's coupling interface adjacent the magnet, when the second portion 64 is urged toward the magnet. In this manner, the legs contact the coupling interface when the driving force urges the second portion 64 toward the magnet, but simply adds weight/mass to the second portion 64 when the driving force urges the second portion away from the magnet. The added weight/mass adds inertia to the second portion 64 which influences the second portion's response to the driving force. More specifically, the resonant frequency of the second portion's motion changes. This in turn influences the second portion's fundamental and harmonic frequencies of the second portion's motion. Contacting the coupling interface of the handpiece prevents further movement of the region of the second portion 64 that lies between the handpiece's leads (34a and 34b in in FIGS. 1-3) toward the magnet. This combined with the momentum of the distal end 66 of the second portion 64 effectively whips the first portion 68 causing the distal end 70 to move quicker and farther than it would normally move when the second portion 64 does not include the brace 62. The legs of the brace 62 also reduce the cyclic deformation of the neck 72 when the second portion 64 is exposed to the driving force, and thus reduce possible damage to the second portion 64 when in use.

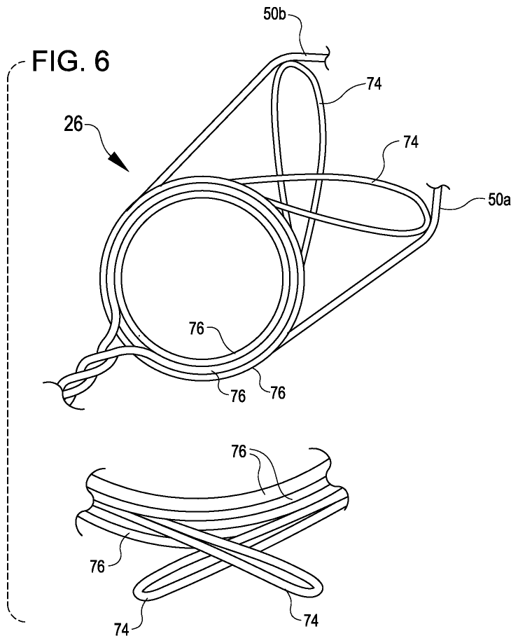

Other embodiments are possible. For example, FIG. 6 shows a brace 74 of that stiffens the coupling of the second portion 26 with the leads 34a and 34b of the handpiece's coupling interface 29 (FIGS. 1-3). The brace 74 influences the motion of the second portion 26 when the driving force urges the second portion 26 in both of the directions indicated by the arrows 46 and 48 (FIG. 3), and throughout the whole range of motion in both directions. In addition, the brace 74 also provides a more secure coupling with the handpiece's coupling interface 29.

The brace 74 may be configured as desired to provide continuous support to the second portion 26. For example, in this and other embodiments the brace 74 is simply an ancillary section of one of the coils 76, that extends out away from the coil 76 toward one of the second portion's leads 50a and 50b, and is secured to the lead. More specifically, the brace 74 includes two such ancillary sections, one that is secured to the lead 50a, and the other that is secured to the lead 50b. Because the brace 74 is an ancillary section of a coil 76, electric current flowing through the second portion 26 also flows through the brace 74.

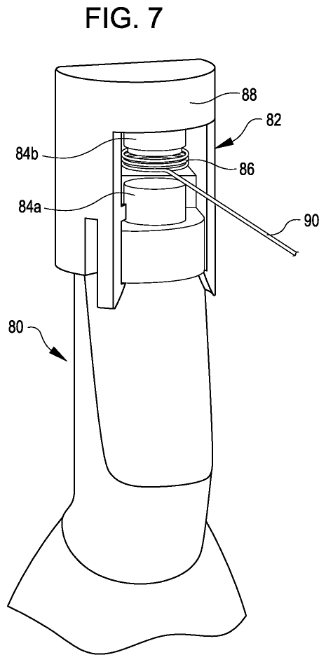

FIG. 7 shows a handpiece 80, according to another embodiment of the invention. The handpiece 80 is similar to the handpiece 28 shown and discussed in conjunction with FIGS. 1-3, except that the coupling interface 82 of the handpiece 80 includes two separate magnets 84a and 84b. The magnet 84a is located below the second portion 86 of the activator 88, much like the magnet (38 in FIGS. 1-3) is. The magnet 84b is located above the activator's second portion 86, and is held there by a cap 88 that is releasably fastened to the handpiece 80. To promote the driving force generated by the handpiece 80, the magnets 84a and 84b are oriented such that their polarities are reversed relative to each other—i.e. they repel each other.

The preceding discussion is presented to enable a person skilled in the art to make and use the invention. Various modifications to the embodiments will be readily apparent to those skilled in the art, and the generic principles herein may be applied to other embodiments and applications without departing from the spirit and scope of the present invention. Thus, the present invention is not intended to be limited to the embodiments shown, but is to be accorded the widest scope consistent with the principles and features disclosed herein.

What is claimed is:

1. An activator for heating and agitating an irrigant inside a tooth's root canal, the activator comprising:
a first portion operable to heat and physically agitate an irrigant disposed in a tooth's root canal, the first portion being sized and configured to extend into the tooth's root canal via a hole in the tooth's dentin; and
a second portion operable to move the first portion in response to a driving force that the second portion receives, the second portion being sized and configured to move the first portion while the first portion extends into the tooth's root canal.

2. The activator of claim 1 wherein the first portion is operable to generate heat by resisting the flow of an electric current through the first portion.

3. The activator of claim 1 wherein the first portion is operable to agitate the irrigant disposed in the tooth's root canal by vibrating inside the tooth's root canal.

4. The activator of claim 2 wherein the first portion includes a single wire having a length, the single wire being folded onto itself at a location that is half of the wire's length, and twisted to form a braid that includes a first strand and a second strand, wherein when electric current flows through the wire to generate heat, the electric current flows through the first strand out toward the location of the fold, and then through the second strand back away from the location of the fold.

5. The activator of claim 1 wherein:
the second portion includes a proximal end and a distal end opposite the proximal end, and
the first portion extends from the second portion's distal end.

6. The activator of claim 1 wherein the driving force includes a magnetic force within a magnetic field.

7. The activator of claim 1 wherein:
the driving force includes a magnetic force within a magnetic field, and
the second portion is operable to move the first portion by generating an electromagnetic field that reacts with the magnetic field.

8. The activator of claim 1 wherein
the first portion is operable to generate heat by resisting the flow of an electric current through the first portion, and
the second portion is sized and configured to generate an electromagnetic field when the electric current that flows through the first portion flows through the second portion.

9. The activator of claim 1 wherein the second portion is configured to include a loop of wire such that when electric current flows through the loop of wire, the electric current generates an electromagnetic field.

10. The activator of claim 9 wherein the second portion is configured to include a brace operable to support the second portion while the second portion moves the first portion in response to the driving force.

11. A system for heating and agitating an irrigant inside a tooth's root canal, the system comprising:
a handpiece operable to generate a driving force, wherein the handpiece includes:
a body sized and configured to be held by a dental professional, and
a coupling interface that includes a driver operable to generate a driving force;
an activator for heating and agitating an irrigant inside a tooth's root canal, the activator comprising:
a first portion operable to heat and physically agitate an irrigant disposed in a tooth's root canal, the first portion being sized and configured to extend into the tooth's root canal via a hole in the tooth's dentin; and
a second portion coupleable with the handpiece's coupling interface and operable to move the first portion in response to the driving force generated by the handpiece's driver, the second portion being sized and configured to move the first portion while the first portion extends into the tooth's root canal.

12. The system of claim 11 wherein the driver of the handpiece includes a magnet that generates a magnetic field and the driving force includes a magnetic force within the magnetic field.

13. The system of claim 11 wherein the driver of the handpiece includes two magnets each of which generates a magnetic field, and the driving force includes a magnetic force within each of the magnetic fields.

14. The system of claim 11 wherein the driver of the handpiece includes two leads operable to provide electric current to the activator when the activator is coupled with the handpiece.

15. The system of claim 11 further comprising a base station operable to charge the handpiece when the base station is coupled with the handpiece.

16. A method for heating and physically agitating an irrigant inside a tooth's root canal, the method comprising:
extending a first portion of an activator into the pulp chamber of a tooth;
generating heat in the first portion of the activator;
generating a driving force;
exposing a second portion of the activator to the driving force;
with the driving force, moving the second portion of the activator; and
with the second portion's movement, moving the first portion of the activator.

17. The method of claim 16 wherein extending the first portion of the activator into the pulp chamber includes extending the first portion through a hole in the crown of the tooth.

18. The method of claim 16 wherein generating heat in the first portion includes generating an electric current.

19. The method of claim 16 wherein generating heat in the first portion includes resisting the flow of an electric current through the first portion of the activator.

20. The method of claim 13 wherein generating the driving force includes generating an electric current in the second portion of the activator.

21. The method of claim 13 wherein generating the driving force includes generating an electromagnetic field.

22. The method of claim 13 wherein generating the driving force includes generating an electromagnetic field within a magnetic field.

23. The method of claim 13 wherein moving the second portion of the activator includes vibrating the second portion.

24. The method of claim 13 wherein moving the first portion of the activator includes vibrating the first portion.

25. The method of claim 13 wherein moving the first portion of the activator includes generating a standing wave in the first portion.

26. The method of claim 13 further comprising supporting the second portion of the activator with a brace.

27. A method for cleaning a root canal, the method comprising:
coupling an activator to a coupling interface of a handpiece, wherein:
the activator includes a first portion and a second portion,
the coupling interface of the handpiece includes a driver, and
the activator's second portion is coupled with the handpiece's coupling interface;
extending the first portion of the activator into the pulp chamber of a tooth;
generating heat in the first portion of the activator;
with the driver, generating a driving force;
exposing a second portion of the activator to the driving force;
with the driving force, moving the second portion of the activator; and
with the second portion's movement, moving the first portion of the activator.

28. The method of claim 27 wherein coupling the activator to the coupling interface includes positioning the activator's second portion within a magnetic field generated by a magnet of the driver of the coupling interface.

29. The method of claim 27 wherein coupling the activator to the coupling interface includes coupling the activator's second portion with two electrical leads of the driver of the coupling interface.

30. The method of claim 27 wherein coupling the activator to the handpiece's coupling interface includes fastening a brace of the activator's second portion to the coupling interface.

31. The method of claim 27 wherein:
generating heat in the activator's first portion includes generating an electric current in the first portion, and
generating the driving force includes generating an electromagnetic field with the electric current flowing through the first portion, flowing through the second portion.
